(19) United States
(12) Patent Application Publication
(10) Pub. No.: US 2014/0247537 A1
(43) Pub. Date: Sep. 4, 2014

(54) Medium Voltage Power Distribution in Data Centers

(71) Applicant: Panduit Corp., Tinley Park, IL (US)

(72) Inventor: Ronald A. Nordin, Naperville, IL (US)

(73) Assignee: PANDUIT CORP., Tinley Park, IL (US)

(21) Appl. No.: 14/186,442

(22) Filed: Feb. 21, 2014

Related U.S. Application Data
(60) Provisional application No. 61/771,412, filed on Mar. 1, 2013.

(51) Int. Cl. H02B 7/00

(52) U.S. Cl. CPC H02B 7/00
USPC 361/622

(57) ABSTRACT

A medium voltage power distribution system containing a power distribution cabinet with a first and second power supply is described. The cabinets contain one or more power distribution unit static transfer switch units. These units are connected to both the first and second power supplies of the cabinets. The power distribution unit static transfer switch units each have one or more power distribution blades removably contained within. The power distribution blades have first and second power contacts that respectively electrically engage first and second power contacts on the power distribution unit static transfer switch units wherein the first and second power contacts of the power distribution static transfer switch unit are respectively connected to the first and second power supplies of the power distribution cabinet.

### CROSS REFERENCE TO RELATED APPLICATION

This application claims priority to U.S. Provisional Application No. 61/771,412, filed Mar. 1, 2013, the subject matter of which is hereby incorporated by reference in its entirety.

### FIELD OF THE INVENTION

The present invention relates generally to power distribution and more specifically to medium voltage power distribution for a data center.

### BACKGROUND OF THE INVENTION

Data centers today typically distribute three-phase 208 VAC within the facility, and are migrating to three-phase 480 VAC. Both of these voltage levels are classified as low voltage (LV). The three-phase 480 VAC is transformed down to three-phase 415 VAC, typically within the power distribution unit (PDU), which is in close proximity to the IT-equipment. This lower voltage is required so that the IT-equipment's power supply is compatible.

There is interest in the power distribution of medium voltage AC within the data center for significant CAPX and OPEX cost savings. Medium voltage (MV) is typically defined between 1000 VAC and 35,000 VAC. A voltage value that makes practical sense is 4160 VAC, due to the compatibility with facilities mechanical equipment (such as HVAC units, CRAC/CRAH units, and pump equipment) and the availability of equipment used in data centers (such as transformers, UPS equipment and diesel backup generators). In order to get the maximum efficiency gain from this MV power distribution concept, the MV must be brought as close to the IT-equipment as possible. Also this three-phase 4160 VAC must be converted to no higher than three-phase 415 VAC, so as the single-phase voltage line-to-neutral is no higher than 240 VAC. This is the maximum voltage with which the current IT-equipment's power supply is compatible.

### SUMMARY OF THE INVENTION

A medium voltage power distribution system containing a power distribution cabinet with a first and second power supply is described. The cabinets contain one or more power distribution unit static transfer switch units. These units are connected to both the first and second power supplies of the cabinets. The power distribution unit static transfer switch units each have one or more power distribution blades removably contained within. The power distribution blades have first and second power contacts that respectively electrically engage first and second power contacts on the power distribution unit static transfer switch units wherein the first and second power contacts of the power distribution static transfer switch unit are respectively connected to the first and second power supplies of the power distribution cabinet.

### BRIEF DESCRIPTION OF FIGURES

FIG. 1 shows a system overview of a medium voltage power distribution chain for a data center.

FIGS. 2A and 2B show multiple setups for converting the power distribution from 4160 V to 240 V for the IT-equipment in the IT-equipment power supply cabinet.

FIG. 3 shows medium voltage distribution to the PDU cabinets.

FIG. 4 shows the PDU cabinets being divided into PDU/STS units.

FIG. 5A is a front view of a PDU cabinet showing multiple PDU blades in each PDU/STS unit.

FIG. 5B is a rear view of the STS/PDU cabinet highlighting the power bus connections to the PDU/STS blades.

FIG. 5C is a rear view of the PDU/STS cabinet highlighting the feeder connections.

FIG. 5D is a rear view of the PDS/STS cabinet highlighting the LAN connections.

FIG. 6 shows a front and side view of a PDU/STS unit with blades.

FIG. 7 is a system view showing two configurations for the PDU blades.

FIG. 8 shows a front and rear view of a feeder termination unit.

### DETAILED DESCRIPTION OF THE PREFERRED EMBODIMENTS

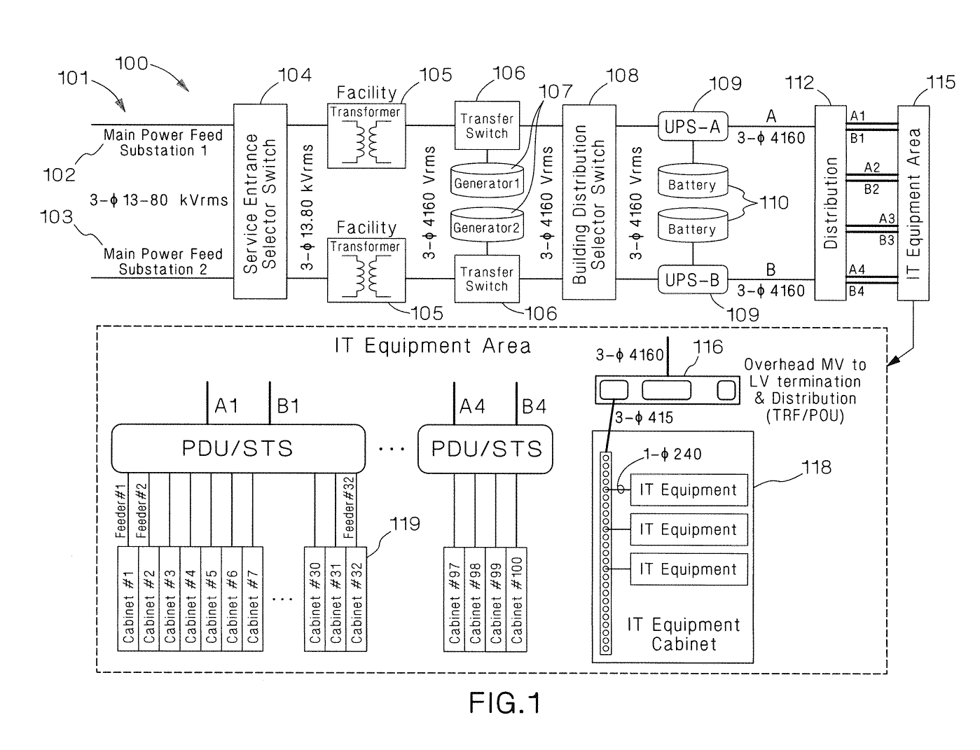

FIG. 1 shows a power distribution chain 100 with high reliability and high availability (e.g., Tier 4) within a data center beginning from the service entrance 101 all the way through to the IT-equipment's power supply in the IT-equipment area 115. FIG. 1 shows a power distribution chain 100 with a main power feed from substation 1 102 and a main power feed from substation 2 103, a service entrance selector switch 104, facility transformers 105 for stepping down the voltage from 13,800 Vrms to 4160 Vrms, transfer switches 106, diesel backup generators 107, a building distribution selector switch 108, UPS supply 109 with battery backup 110, and power distribution 112 for the IT equipment area 115. Diesel backup generators 107, UPS equipment 109 and static transfer switch 106 (STS) are provided to ensure high reliability/availability to the data center. Note that the power that is distributed around in the data center to the power distribution unit (PDU) cabinets 119 is three-phase 4160 VAC, until it reaches the IT-equipment's power supply cabinet 118 which the becomes 240 VAC. Standard distribution techniques are utilized to bring this three-phase 4160 VAC to terminate on the MV to LV conversion unit 116 that can be mounted within the cabinet 118 or above the cabinet 118. Some of the advantages of such architecture include the following:
Utilizing the efficiency gains of a three-phase −4160 VAC distribution as much as possible (meaning as close to the endpoint as possible).
Utilizing capital equipment and copper cost savings as much as possible.
Scalability of the system (e.g., pay as you grow style architecture).

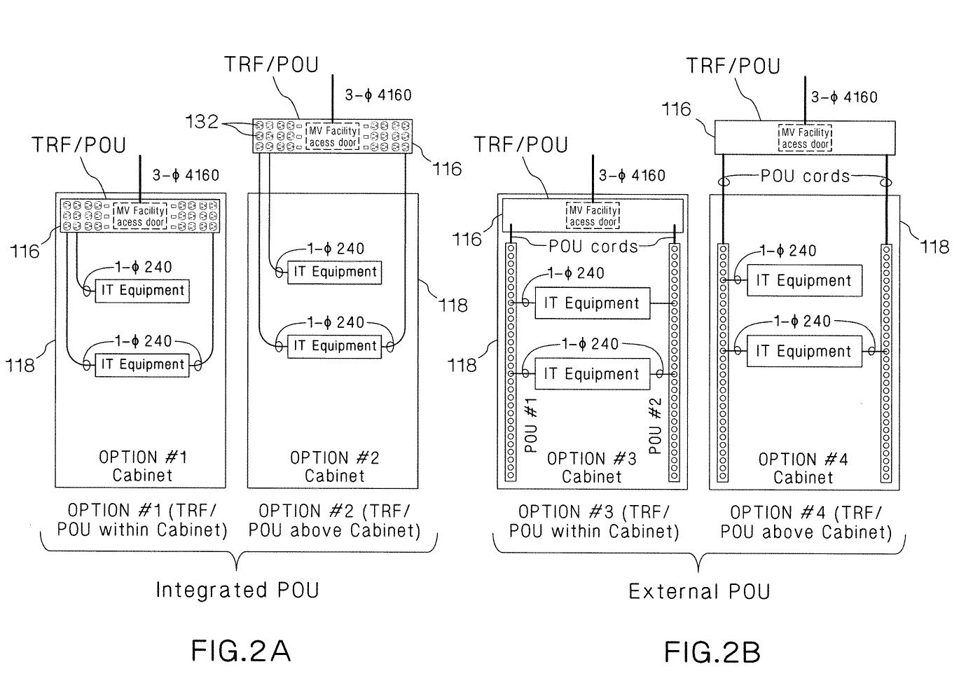

FIGS. 2A and 2B show and multiple setups for converting the power distribution from 4160 V to 240 V for the IT-equipment in the IT-equipment power supply cabinet 118. FIG. 2A shows an integrated setup and FIG. 2B shows an external setup. As shown in FIGS. 2A and 2B, the 4160 VAC from the PDU/STS terminates at a unit that converts MV to LV called the TRF/POU unit 116 (Transformer/Power Outlet Unit). The TRF/POU 116 unit can either reside within the IT-equipment cabinet or above the cabinet to allow a cabinet to roll-in and/or roll-out easily. The main functions of the TRF/POU 116 unit are as follows:
Termination of the three-phase 4160 VAC, as well as provide a secure facility service access panel to allow only trained personnel access to the three-phase 4160 VAC. This is important as only trained personal should have access to the MV.
Convert the three-phase 4160 VAC to three-phase 415 VAC (or equivalent for specific countries); this can be accomplished by a MV to LV transformer mounted within the unit.
Provide IT-equipment access to the three-phase 415 VAC in the following ways:
   Provide a receptacle(s) for a POU plug (may be more than one).
   Provide 240 VAC single phase receptacles 132 for IT-equipment cords.
   Provide a circuit breaker on the 415 VAC side.
   Optionally provide power monitoring at the 415 VAC ingress and/or at the 240 VAC egress side
   Optionally provide 240 VAC egress switch to isolate IT-equipment AC cords.
   Optionally provide remote access (e.g., Ethernet LAN) to the monitored/controlled parameters.

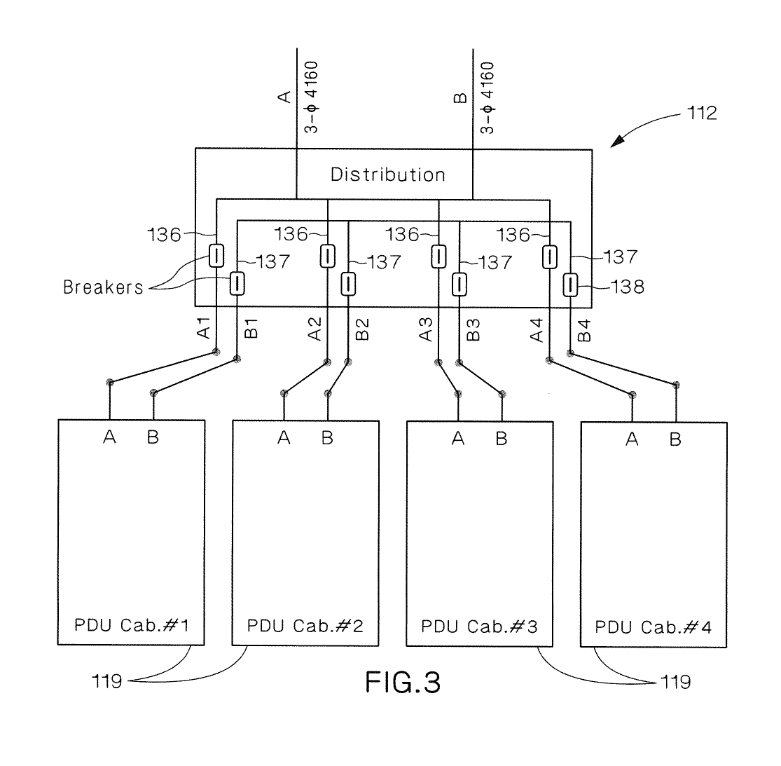

FIG. 3 describes the distribution unit which interconnects the PDU cabinets 119 up towards the UPS within the facility. The A and B power is subdivided into multiple (in this case 4) feeders 136,137 to interconnect the PDU cabinets 119. Each PDU cabinet 119 has its own pair of feeders 136,137. Each feeder has its own circuit breaker 138.

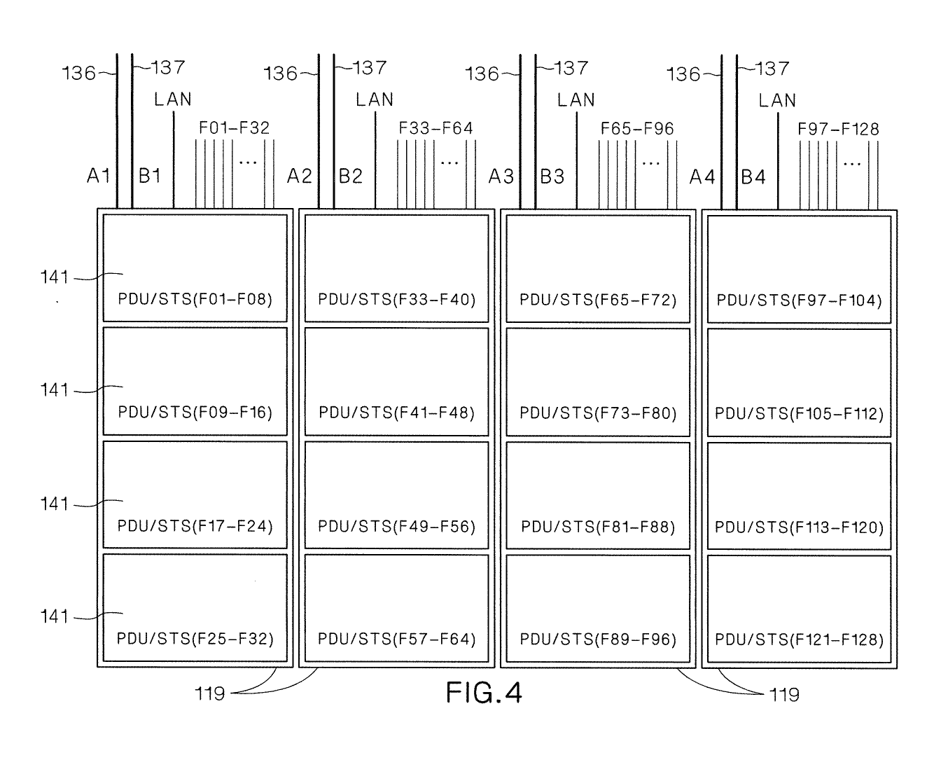

FIG. 4 shows multiple PDU cabinets 119 each having multiple PDU/STS units 141 within each PDU cabinet.

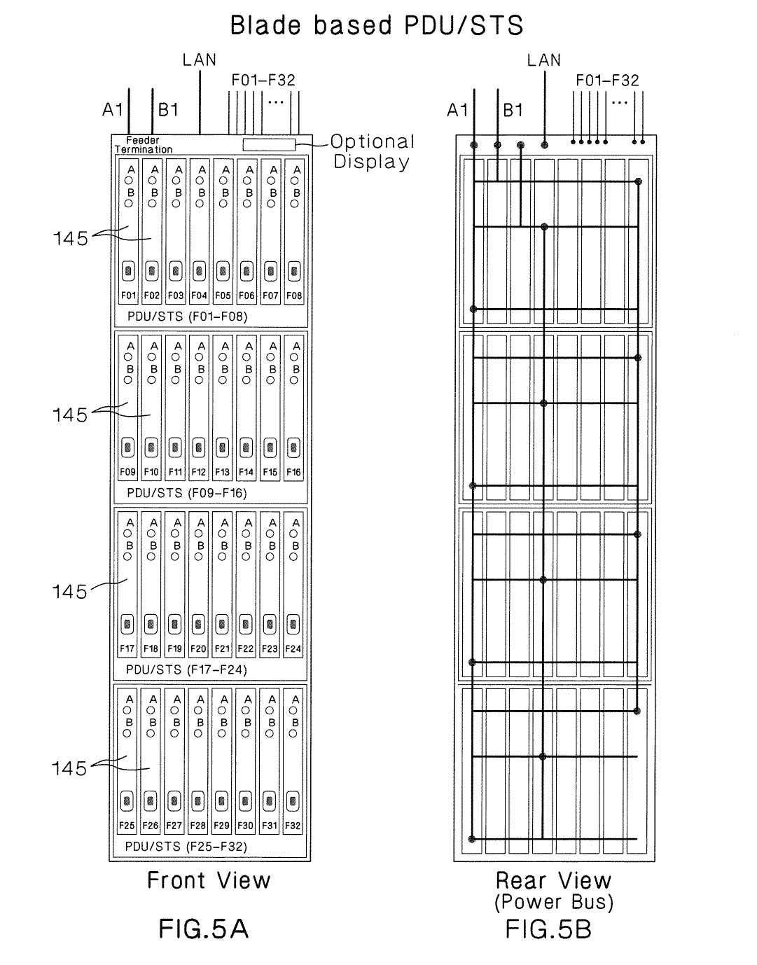

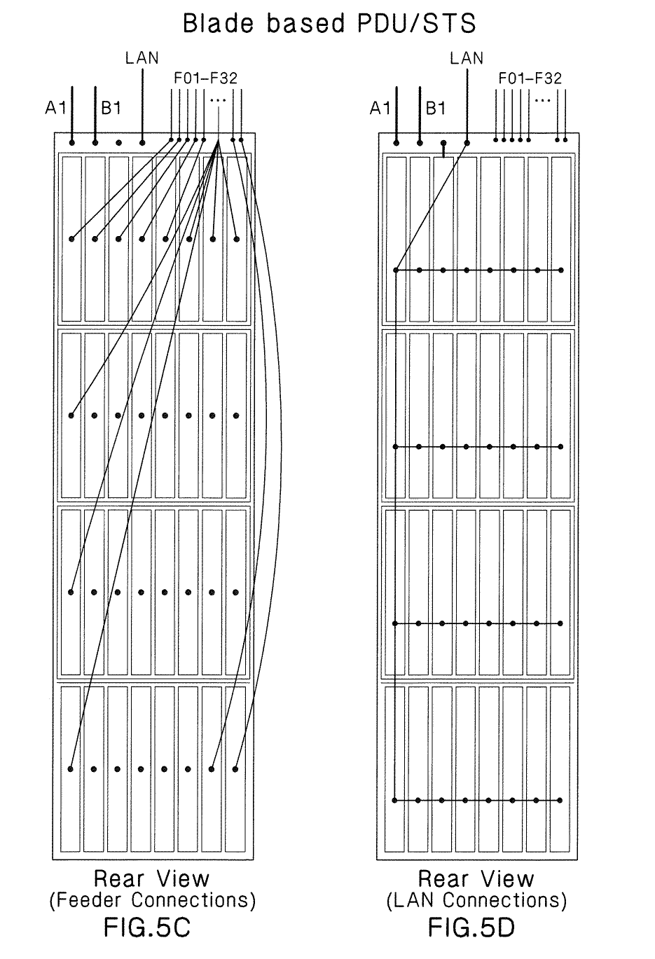

FIGS. 5A-D shows the connectivity of the PDU/STS units within the PDU cabinet 119. The interconnection is always through the feeder termination unit 143 to allow the cabinet to be pre-configured. Each of the PDU/STS units 141 have multiple blades 145 that can be inserted (8 in this case). FIG. 5A shows a front view, FIG. 5B shows a rear view highlighting the power bus connections, FIG. 5C shows a rear view highlighting the feeder connections, and FIG. 5D shows a rear view highlighting the LAN connections.

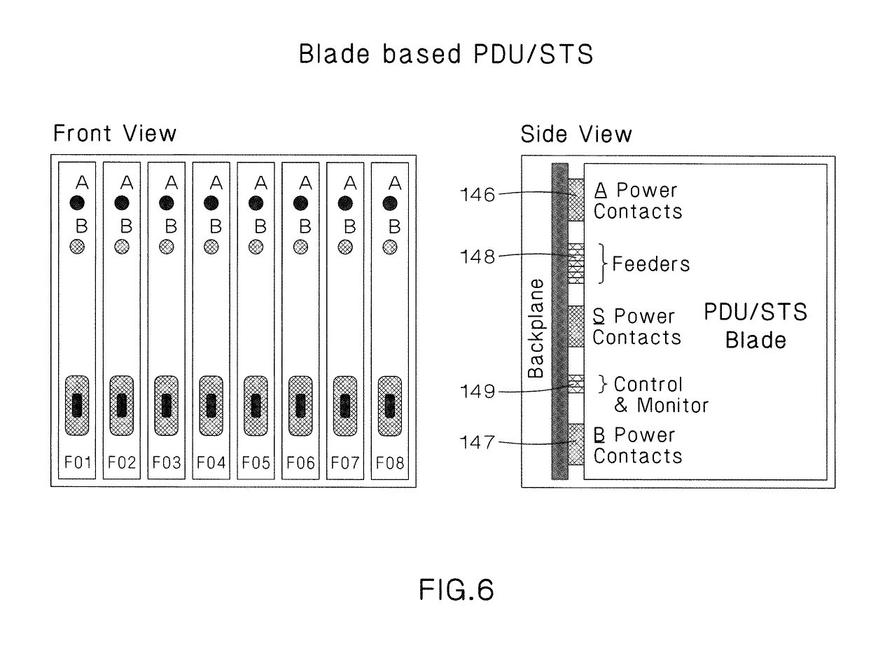

FIG. 6 shows a front and side view of a PDU blade. The blade has A and B power supply contacts 146,147 as well as for feeder contacts 148 and control and monitoring contacts 149.

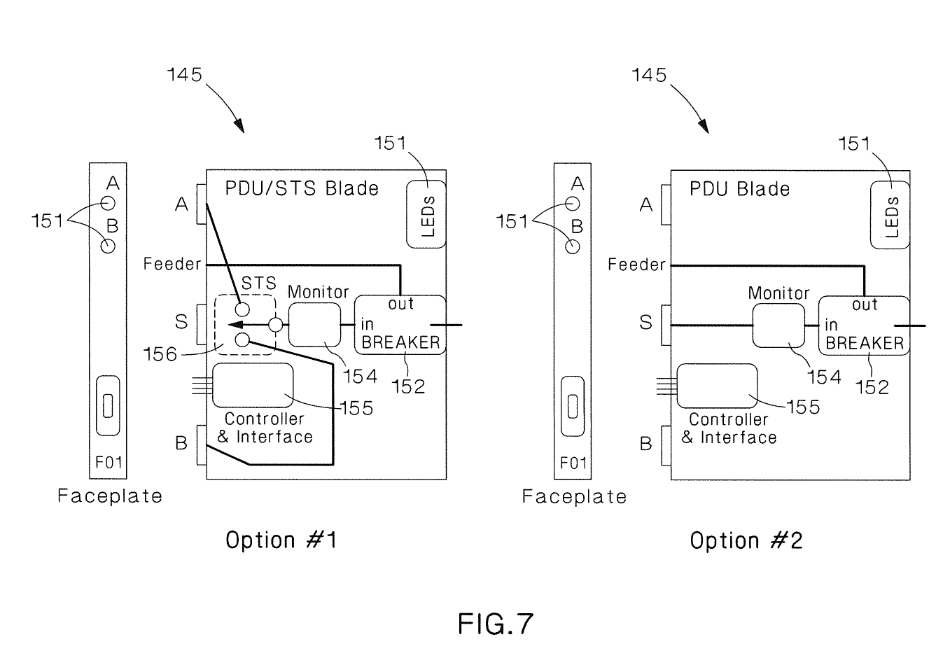

FIG. 7 shows multiple options or configurations for the PDU blades 145 that can insert into a PDU/STS unit including possible connections for an STS 155, monitor 154, circuit breaker 152, LEDs 151, and a controller and interface 155.

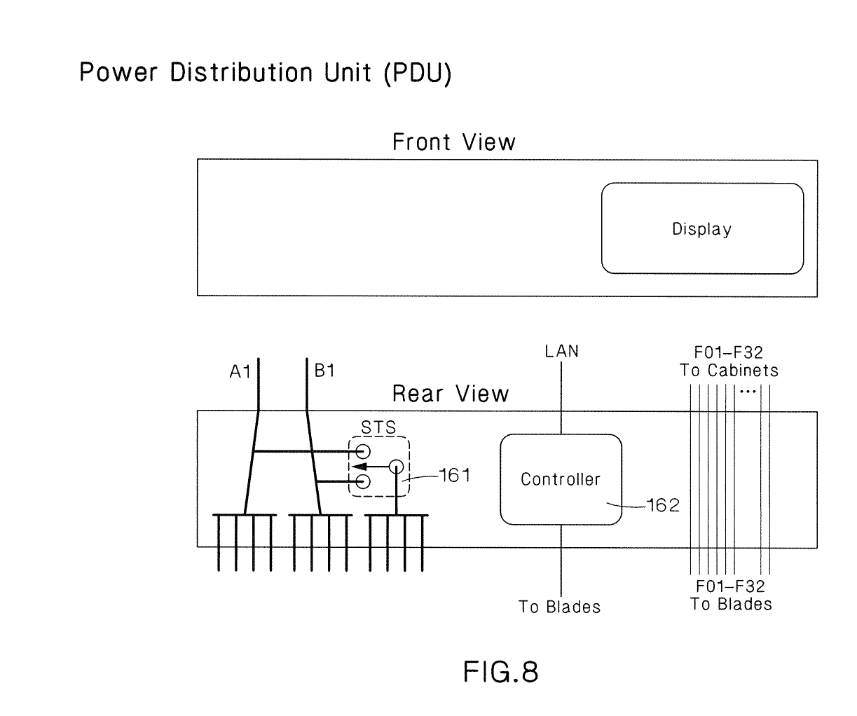

FIG. 8 shows a front and rear view of the feeder termination unit 143 within the PDU cabinet 119 and how it interconnects the PDU/STS units and the external units. It shows the use of an STS 161 to select the A or B power source, a controller 162 to connect the LAN to the blades

While particular embodiments and applications of the present invention have been illustrated and described, it is to be understood that the invention is not limited to the precise construction and compositions disclosed herein and that various modifications, changes, and variations may be apparent from the foregoing without departing from the spirit and scope of the invention as described.

1. A medium voltage power distribution system comprising:
a power distribution cabinet with a first and second power supply;
at least one power distribution unit static transfer switch unit contained within the power distribution unit, each power distribution unit static transfer switch unit of the at least one power distribution unit static transfer switch unit having connections to both the first and second power supply of the power distribution unit; and
at least one power distribution blade removably contained in the at least one power distribution unit static transfer switch unit, the power distribution blade having first and second power contacts to respectively electrically engage first and second power contacts on the power distribution unit static transfer switch unit wherein the first and second power contacts of the power distribution static transfer switch unit are respectively connected to the first and second power supplies of the power distribution cabinet.

2. The medium voltage power distribution unit of claim 1 wherein the at least one power distribution blade further comprises feeder contacts.

3. The medium voltage power distribution unit of claim 1 wherein the at least one power distribution blade further comprises control and monitoring contacts, the contacts being electrically connected to control and monitoring circuitry contained within the at least one power distribution blade.

4. The medium voltage power distribution unit of claim 1 wherein the at least one power distribution blade contains a circuit breaker.

5. The medium voltage power distribution unit of claim 1 wherein the at least one power distribution blade contains a transfer switch to enable to selection of the first or second power supply of the power distribution unit.
